(19) United States
(12) Patent Application Publication
(10) Pub. No.: US 2016/0008661 A1
(43) Pub. Date: Jan. 14, 2016

(54) SYSTEM AND METHOD FOR EVALUATING THE MOTION OF A SUBJECT

(71) Applicants: UNIVERSIDADE DE AVEIRO, Aveiro (PT); STROKE OF GENIUS, LDA., Aveiro (PT)

(72) Inventors: Virgílio António FERRO BENTO, Aveiro (PT); Vítor Pedro TEDIM RAMOS CRUZ, Vila Nova De Gaia (PT); Márcio Filipe MOUTINHO COLUNAS, Aveiro (PT); David Manuel DIETEREN RIBEIRO, Aveiro (PT)

(21) Appl. No.: 14/764,099

(22) PCT Filed: Feb. 21, 2014
(86) PCT No.: PCT/PT2014/000014

§ 371 Date: Jul. 28, 2015

Related U.S. Application Data
(60) Provisional application No. 61/767,367, filed on Feb. 21, 2013.

(51) Int. Cl. A63B 24/00; G01B 7/00; G01P 15/00; G06K 9/00; G01C 19/00

(52) U.S. Cl. CPC A63B 24/0006; G06K 9/00342; G01C 19/00; G01P 15/00; G01B 7/00; A63B 2024/0012

(57) ABSTRACT

The present invention intends to solve the problem of automatically analysing the movement performed by a subject. Disclosed is a 3D motion tracking method that allows a user to perform a control movement and so generating a tunnel of motion. Using the tunnel of motion a user can repeat the motion but limiting the movement within the boundaries of the tunnel. The disclosed motion analysis system and methods can be used in medical rehabilitation, sport, science, gaming, robotics, cinema or force feedback applications.

### TECHNICAL FIELD

The present application relates to a system and method for evaluating the motion of a subject.

### BACKGROUND ART

We live in a modern fasted paced society where stroke is the third leading cause of death and serious adult permanent disability. In the United States (US) there are approximately 795,000 new stroke victims per year. Furthermore, seven million people, who are in the US alone, have survived a stroke and are living with the effects afterwards. Also, these numbers are predicted to rise in the coming years due to an aging population e.g. the baby-boomer generation turned 65 in 2011. This situation puts a heavy burden onto national healthcare services and as populations continue to age the demand for rehabilitation services will continue to rise. The statistics mentioned above do not reflect the number of relatives such as husbands, wives and children who care for these victims and who are also affected in their own way of life. Worldwide nearly 50% of stroke survivors remain with a significant disability of arm and hand function after they are discharged from the hospital. Therefore, a correct and qualitative rehabilitation is of the essence. Rehabilitation commences at the hospital, as soon as possible after the stroke. Patients, who are in a stable situation, should begin rehabilitation within a few days after the stroke has occurred. Depending on the severity of the post stroke effects, the patient should continue rehabilitation after being discharged from the hospital.

Rehabilitation is defined in medical terms as the process of making someone fit to work or to live an ordinary life again. There are three golden rules to follow for a successful post-stroke rehabilitating program: high-intensity, repetitive task-specific practice and feedback on performance.

There are several solutions and methods to be found for rehabilitation of stroke victims. Some of these methods use pharmaceutical solutions for patient rehabilitation, but clinical trials for new drugs are costly and time consuming. Alternatively, rehabilitation therapy focussed on repeated physical tasks is very common, but the extension of recovery depends on the intensity of the rehabilitation program followed within a preferred time period. Furthermore the scarcity of specialized medical personnel and the difficult organisation of hospital services and infrastructures prevent stroke victims from receiving an effective post stroke rehabilitation treatment. Besides, because of the above-mentioned reasons, stroke patients are receiving less therapy eventually being discharged from the hospital and going home sooner than they should. High-tech rehabilitation could be one of the several solutions enabling stroke victims to receive a more intensive and efficient rehabilitation program. These types of high-tech solutions enable hospitals and medical specialist to provide a more intense and maximize the effectiveness of post-stroke rehabilitation to a larger number of patients without a constant supervision. Although introducing technology into rehabilitation services could be a solution, there are also some drawbacks. Robotic assisted therapy such as the “MIT MANUS” or the “Hocoma Armeo”, are showing great potential but have the need for a specialized infrastructure due to their size. GENTLE/S and other robotic systems have also been established as a valid rehabilitation tool. However, as in the cases of the MIT-MANUS or the other systems mentioned above, their use is only possible in a clinical environment due to a high-complexity and cost. In addition, these types of systems need a specialized staff to operate or maintain which also makes the overall costs of such a system increase.

In recent years low costs camera based and sensor based systems have become miniaturized and more common. These systems such as the camera based “Microsoft Xbox Kinect®” or inertial sensor based systems such as Nintendo Wii® “nunchuck” are primarily directed towards the gaming industry. Of course these systems are intended to be used in a home setting and are typically much less sophisticated then the above-mentioned robotic systems. Although less sophisticated, this type of technology enables developers to design low costs portable rehabilitations systems, suitable for home. One such as system is the Hocoma's “Valedo Motion” system which uses inertial systems to measure spine movements but is not used in post-stroke therapy. There is also the Tyromotion's “Pablo” system which is also based on inertial measurements similar to Nintendo's Wii® “nunchuck” used for post-stroke rehabilitation.

### SUMMARY

The present application discloses a method of operating a data-processing system comprising the steps:
recording a reference motion from a subject;
recording the mimicking of a reference motion; and
analysing if the mimicked motion occurs inside a tunnel of motion of the reference motion.

One embodiment of the present application discloses a method of operating a data-processing system, wherein the step of recording a reference motion from a subject comprises the step of recording reference coordinate samples in at least one dimension, while performing a reference motion.

A further embodiment of the present application discloses a method of operating a data-processing system according to any of the previous claims, wherein the step of recording the mimicking of a reference motion comprises the step of recording coordinate samples in at least one dimension, while mimicking a reference motion.

Another embodiment of the present application discloses a method of operating a data-processing system, wherein the step of analysing if the mimicking of a reference motion occurs inside a tunnel of motion comprises the following steps:
calculating the distance from a coordinate sample to a reference coordinate sample; and
analysing if at least one distance between the coordinate sample and the reference coordinates samples is lesser than the radius of the spheres of the reference tunnel of motion.

The present application also discloses a data processing system comprising means for carrying out the method above-mentioned.

One embodiment of the present application discloses a data processing system comprising at least one sensor module.

A further embodiment of the present application discloses a data processing system, wherein the sensor module comprises:
a gyroscope;
an accelerometer;
a magnetometer; and
a microcontroller.

An embodiment of the present application discloses a data processing system, wherein the sensor module comprises a camera.

Another embodiment of the present application discloses a data processing system, wherein the sensor module transmits or sends data from a reference motion of a subject.

One embodiment of the present application discloses a data processing system, comprising sensor modules with wireless communication means.

The present application also discloses the use of the data processing system in:
medical rehabilitation;
sports;
gaming;
cinema;
3D motion capture for cinema;
industrial robotics; or
force feedback.

### General Description

The present application intends to solve the problem of automatically analysing the movement performed by a subject.

In order to provide the means to correctly analyse movements performed by a subject and give feedback on the latter, the present application intends to combine the advantages of low cost systems. Measurements of motion from a subject are used, based on a motion tracking system.

The system quantifies actual movement performance of a subject against a controlled movement by doing repeated predefined tasks. Areas outside medical rehabilitation, such as sports, gaming, cinema, 3D motion capture for cinema, industrial robotics or force feedback, can use the disclosed system.

At the system's core, there is a 3D motion capture system. The capture system comprises sensor modules to provide kinematic data regarding movements of the user. In one embodiment, the capture system comprises inertial sensors comprises at least one wearable sensor using inertial measurements in order to determine position. In other embodiments, a camera based 3D tracking system, a robotic system or a radio frequency tracking system can also acquire kinematic data.

The sensor system transmits sensor data to a computational device, which performs analysis to said data. The received sensor data is then handled by a kinematic model and from this model, kinematic data is transformed and obtained in form of 3D coordinates (x,y,z), enabling the mapping of points in space with real dimensions.

The following steps achieve movement analysis within a tunnel of motion using the above system. First, the user performs a controlled movement while coordinate samples are recorded as a path. After that, the user must repeat the same movement aiming to perform minimal error to the recorded path. The system achieves this by calculating virtual spheres with a prefixed radius around the samples of the recorded path. Sampling the path at a high frequency and the superimposing of the aforementioned spheres, allows the construction of a tunnel of motion. The generated tunnel of motion restricts the user's movements within the boundaries of said tunnel.

In one embodiment, the system is used during a physical rehabilitation session. After recording the data and generating the tunnel of motion regarding the control movement, the user must then repeat the same movement aiming to minimize the error between the two. If a user escapes the tunnel's boundaries, the system will register the occurrence. Modifying the prefixed radius of spheres configures different levels of difficulties, therefore making the tunnel wider of narrower.

The system disclosed herein has no need for a specialized infrastructure or specialized staff to operate or maintain, which makes the overall costs of such a system accessible and implementable in multiple environments.

In the above-described embodiment of a physical rehabilitation session, the patient can record the tunnel of motion's path with the help of a therapist and repeat the recorded movement afterwards, optionally outside the clinical environment. Hence, the possibility to practice in various scenarios allows achieving high intensity of therapy, one of the golden rules for recovery.

### BRIEF DESCRIPTION OF DRAWINGS

Without intent to limit the disclosure herein, this application presents attached drawings of illustrated embodiments for an easier understanding.

FIG. 1 illustrates one embodiment of the present application, where the reference numbers show:

1—tunnel of motion

2—inertial sensor modules

3—computer with serious game software

4—patient doing a complex motor task

FIG. 2 illustrates an architectural view of a single sensor module, where the reference numbers show:

5—digital gyroscope

6—digital accelerometer

7—digital magnetometer

8—microcontroller

9—battery charger

10—power regulation

11—wireless communication

FIG. 3 illustrates a global comparison between a subject performing tasks with and without motion tunnel, where the reference numbers show:

1—tunnel of motion

FIG. 4 illustrates a concept view of the tunnel of motion used as a reference in the performance of a complex motor task, where the reference numbers show:

1—tunnel of motion

FIG. 5 illustrates a frontal view of the tunnel of motion comprised of N spheres, where the reference numbers show:

1—tunnel of motion

12—shoulder joint

13—elbow joint

FIG. 6 illustrates a frontal and sagittal view of the tunnel of motion, where the reference numbers show:

1—tunnel of motion

12—shoulder joint

13—elbow joint

### MODE(S) FOR CARRYING OUT EMBODIMENTS

Referring to the drawings, herein are described optional embodiments in more detail, which however are not intended to limit the scope of the present application.

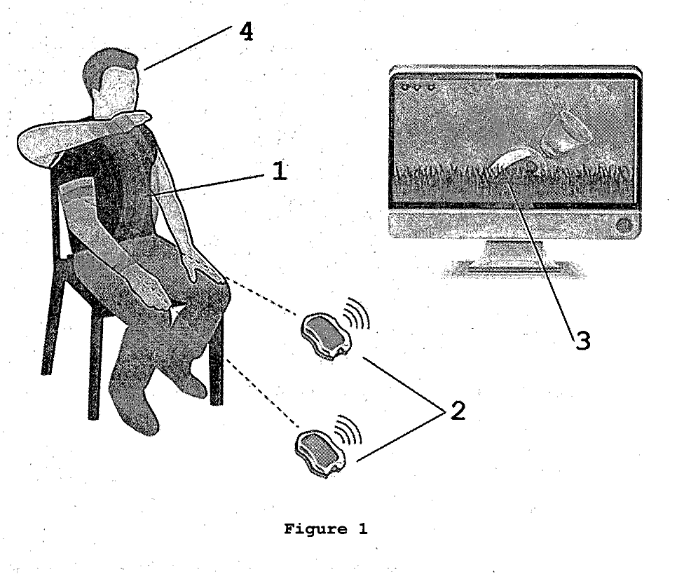

FIG. 1 shows a global overview of the system. The system displayed with the tunnel of motion (1), as an example there are at least two sensor modules (2) attached to the upper limb segment of a subject (4), central console software running on a computer (3). This type of sensor can be easily replaced with a different type of 3D tracking technology such as camera based system. In this embodiment, the subject performs repeated complex motor tasks prescribed by a clinician in form of a game that is being displayed on the computer (3). The user performs a correct movement when the motions stay within the boundaries of the tunnel of motion (1). Software is executed on a computer (3) to generate the appropriate kinematic model and test if the current positioning of the user is within the tunnel of motion (1).

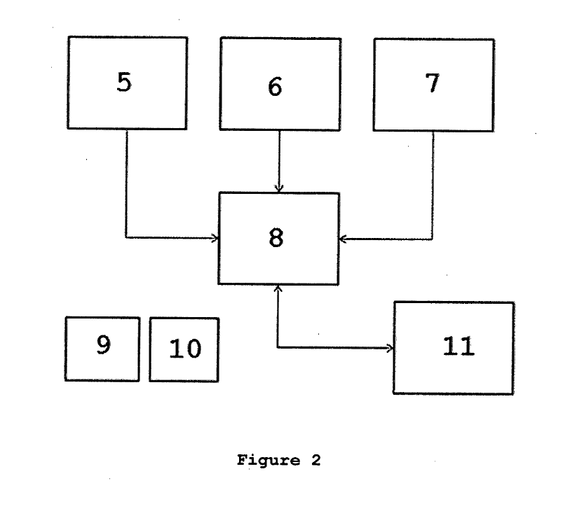

FIG. 2 shows an architectural illustration of an inertial sensor module used to gather sensor data. The sensor used to obtain an error free orientation estimation comprises: a digital gyroscope (5), which measures angular rate; an accelerometer (6), which measures acceleration; and a digital magnetometer (7), which measures heading using the earth's magnetic field. At the core of the device, there is a microcontroller (8), which outputs fused sensor data in form of a quaternion. Data obtained from the various sensors is fused and then transmitted through a wireless communication module (11) to a computer where it is further processed.

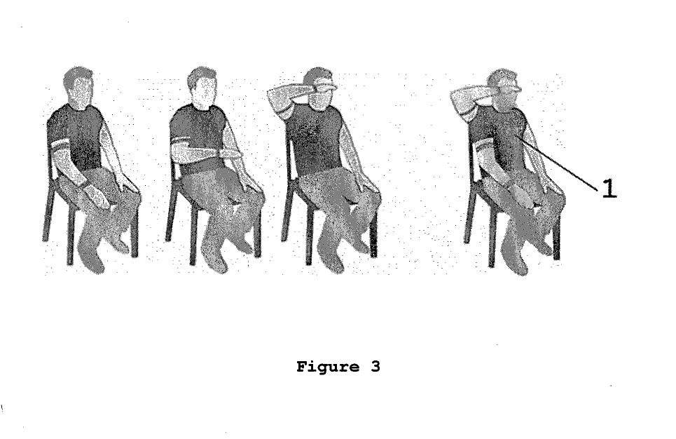

FIG. 3 shows a subject performing a complex motor task. The subject aims to repeat this task several times within the boundaries of the tunnel of motion (1). Developing a motion capture system that acquires all the relevant kinematics of the motor execution performed by the subject, enables the qualification of several important features such as the range of movements, how closer is it to a normal execution and its deviation from the predefined path of execution. These features qualify the movement in a set of intuitive metrics, familiar to the clinical staff.

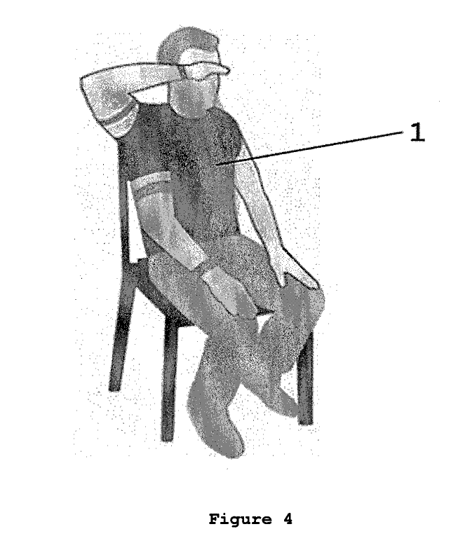

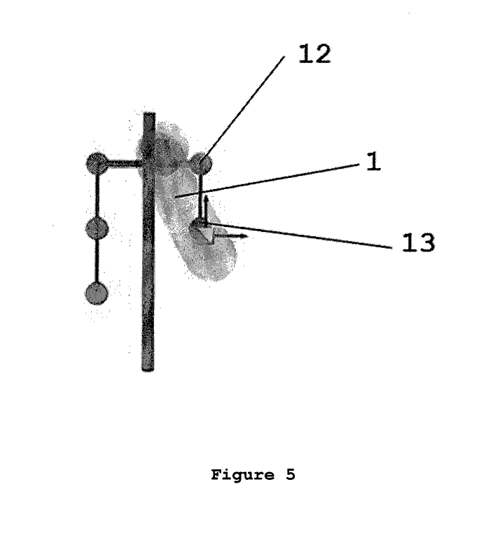

The tunnel of motion (1), as depicted in FIG. 4, was developed with the idea to automate quantification of the correct performed motor tasks. The quality of the movement is calculated from the comparison of the kinematics of the actual performance against a pre-set control movement. The control is obtained in the clinical environment and relative to the motor execution of the task, evaluated by the clinician as the best execution possible. Using this methodology, the patient should replicate in ambulatory the performance exhibited in a clinical environment. The control data is updated in each training session with a clinician, following the motor improvement of the user. As depicted in FIG. 5 the kinematics acquired are relative to the position of the elbow (12) and wrist (13) in each instant of the motor execution.

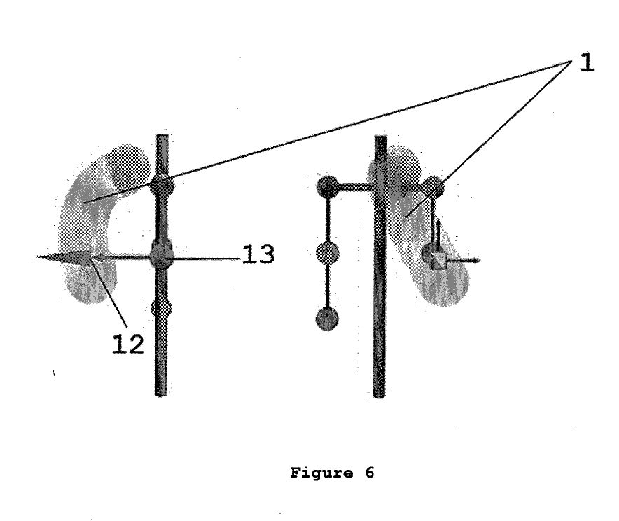

The tunnel of motion can be created in a variety of different ways. One approach uses the 3D vectors acquired by using sensor data and a kinematic model. From these vectors, a control path is defined mapping N spheres with radius r_{diff} centred in each position of the wrist (see FIGS. 5 and 6). Using this geometrical approach, superimposing control spheres in time instants creates a tunnel of motion (1). The total number of spheres N is given by:

N=T*fₛ

where T is the duration of the motor execution and fₛ is the sampling rate at which the kinematics were acquired. The tunnel of motion's path is given by:

P_{c}(n)=<X_{c}(n),Y_{c}(n),Z_{c}(n)>,∀nε[0,N]

where P_{c}(n) are the 3D coordinates of sample n.

For the movement to be decided as correctly performed, the execution should be as close as possible to the one performed in the clinical environment under the supervision of the clinician. In terms of kinematics this analysis is simplified by verifying if the position of the wrist is inside the tunnel of motion defined by the optimal path.

Each position of the wrist is given by:

P(t)=<X(t),Y(t),Z(t)),∀tε[0,T]

where P(t) are the 3D coordinates of the wrist at the time t. The movement is determined to be correctly performed if:

$${r}_{diff} \geq ‖ P ( t ) - {P}_{c} ( n ) ‖ ∀ \{ \begin{matrix}n ∈ [ 0 , N ] \\ t ∈ [ 0 , T ]\end{matrix}$$

where ∥P(t)−P_{c}(n)∥ is, in one embodiment, the distance between the wrist's current position and each sample of the tunnel of motion's reference path.

This formulation of the problem allows us to define, for the same motor task, several different levels of difficulty. This is achieved by adjusting the parameter r_{diff}, which defines the radius of the spheres and therefore defines the maximum deviation possible from the control which is fixed throughout the execution of the motor task. Furthermore, this type of analysis simplifies the process of including new tasks for the system to evaluate.

Although the above-mentioned description contains significant detail, it should not be interpreted as a limiting scope. As an example, sensor data could be obtained from a 3D camera based tracking system or any third party inertial tracking system. Furthermore, the tunnel of motion could also be acquired by using other analytical and mathematical approaches, such as 3D interpolation of the kinematic data (e.g. Lagrange polynomial interpolation, cubic spline interpolation). Considered are also all methods related to image data interpolation generated by the camera tracking system. The tunnel of motion can also be applied at multiple joints such as elbows, shoulder or knees simultaneously creating so a multi tunnel of motion application, which enables processing and analysing a specific motor task in all the considered joints in real time. The method will also allow to simultaneously analysing the execution of different motor tasks at the same time. Also, we can apply this method outside the area of rehabilitation, one example could in sports science where we could accurately quantify performance of a golf player's swing or in tennis analysing back and forehand or service performance. Furthermore, sensors could also be placed on lower limbs in order to provide lower limb rehabilitation to those impaired of walking or suffering from, hand or spinal cord injury. Such alterations would not alter the nature of the present disclosure. Thus, the scope of the present application should be fixed by following claims rather than any specific examples provided.

Naturally, the present embodiment is not in any way limited to the embodiments described in this document and a person with average knowledge in the field will be able to predict many possible changes to it without deviating from the main idea, as described in the claims.

1. A method of operating a data-processing system comprising the steps:
recording a reference motion from a subject;
recording the mimicking of a reference motion; and analysing if the mimicked motion occurs inside a tunnel of motion of a reference motion.

2. A method of operating a data-processing system according to claim 1, wherein the step of recording a reference motion from a subject comprises the step of recording reference coordinate samples in at least one dimension, while performing a reference motion.

3. A method of operating a data-processing system according to claim 1, wherein the step of recording the mimicking of a reference motion comprises the step of recording coordinate samples in at least one dimension, while mimicking a reference motion.

4. A method of operating a data-processing system according to claim 1, wherein the step of analysing if the mimicking of a reference motion occurs inside a tunnel of motion comprises the following steps:
calculating the distance from a coordinate sample to a reference coordinate sample; and
analysing if at least one distance between the coordinate sample and the reference coordinates samples is lesser than the radius of the spheres of the reference tunnel of motion.

5. A data processing system comprising means for carrying out the method described in claim 1.

6. A data processing system according to claim 5, comprising at least one sensor module.

7. A data processing system according to claim 5, wherein the sensor module comprises:
a gyroscope;
an accelerometer;
a magnetometer; and
a microcontroller.

8. A data processing system according to claim 5, wherein the sensor module comprises a camera.

9. A data processing system according to claim 6, wherein the sensor module transmits or sends data from a reference motion of a subject.

10. A data processing system according to claim 6, comprising sensor modules with wireless communication means.

11. Use of the data processing system described in claim 5 in:
medical rehabilitation;
sports;
gaming;
cinema;
3D motion capture for cinema; industrial robotics; or force feedback.
